(19) United States
(12) Patent Application Publication
(10) Pub. No.: US 2004/0100129 A1
(43) Pub. Date: May 27, 2004

(54) Removable composite roof panel system

(76) Inventors: Patrick M. Palajac, Dearborn, MI (US); Daniel W. Atkinson, Royal Oak, MI (US); Riad E. Michael, Washington, MI (US); Ted Sawdon, Royal Oak, MI (US)

Correspondence Address: Ralph E. Smith, DaimlerChrysler Intellectual Capital Corporation, CIMS 483-02-19, 800 Chrysler Drive, Auburn Hills, MI, 48326-2757, US

(21) Appl. No.: 10/306,353

(22) Filed: Nov. 26, 2002

(51) Int. Cl. B60J 7/19

(52) U.S. Cl. 296/218

(57) ABSTRACT

A roof system that allows the roofing style of a vehicle to be changed. The roof system includes a steel body-in-white roof body that is bonded with a composite frame via an adhesive. A mechanical latching arrangement is arranged on a removable composite roof panel. The mechanical latching arrangement allows the removable composite roof panel to be attached to and to be detached from the composite frame. The composite frame includes a water seal that seals to the removable composite roof panel.

### FIELD OF THE INVENTION

The present invention relates to a roof system for a vehicle.

### BACKGROUND INFORMATION

Composite roof panels are being used in vehicle construction to facilitate manufacturing of the vehicle. Instead of installing the roof of the vehicle in the body shop, composite roof panels may be installed in trim-chassis-final production lines. Current composite roof panels are permanently bonded to the roof structure of the vehicle. The panels are very difficult to replace with other panels.

### SUMMARY OF THE INVENTION

The roof system according to the present invention allows vehicle owners to change the roofing style of a vehicle. The roof system according to the present invention includes, for example, a conventional steel body-in-white roof body, a composite roof body, a metal roof body, a plastic roof body, or a fiberglass roof body that is bonded with a composite frame via an adhesive. A conventional mechanical latching arrangement is situated on a removable composite roof panel that allows the removable composite roof panel to attach to and detach from the composite frame. The composite frame includes a water seal that seals to the removable composite roof panel.

### BRIEF DESCRIPTION OF THE DRAWING

FIG. 1 shows an exemplary embodiment of the roof system according to the present invention.

FIG. 2 shows a side of the exemplary embodiment of the roof system according to the present invention.

### DETAILED DESCRIPTION

The roof system according to the present invention allows vehicle owners to change the roofing style of a vehicle. Vehicle owners may choose from various roof styles and easily change the roof of the vehicle. Roof panels according to the present invention are removable and are attachable to the vehicle.

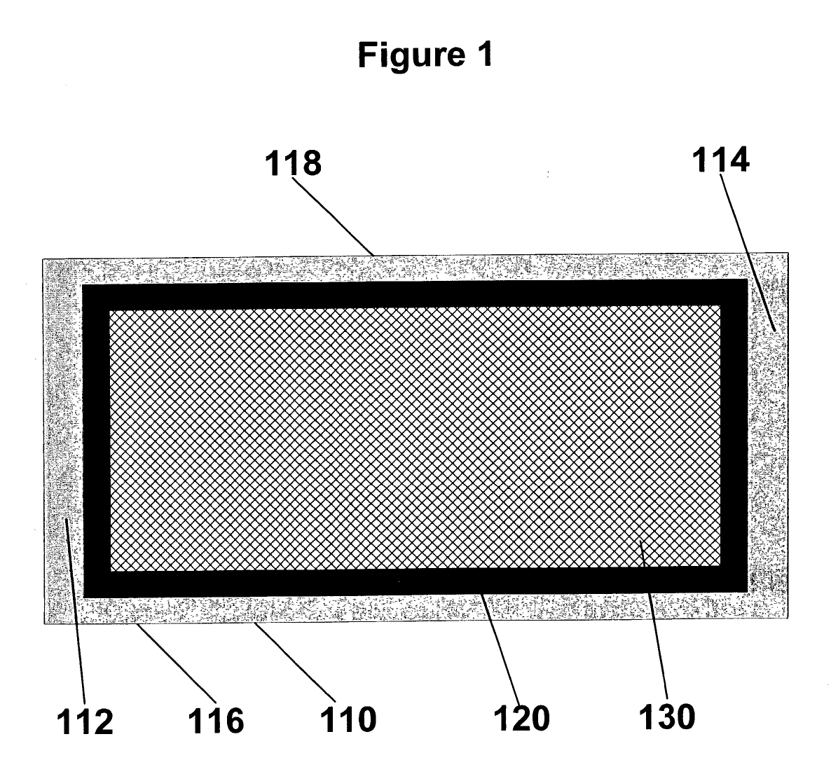

FIG. 1 shows an exemplary embodiment of the roof system according to the present invention. The exemplary embodiment includes a roof body 110 that is bonded to a composite frame 120 via an adhesive. The roof body may be a conventional steel body-in-white roof body, a composite roof body, a metal roof body, a plastic roof body, or a fiberglass roof body. A conventional mechanical latching arrangement is situated on a removable composite roof panel 130. The removable composite roof panel 130 is provided that is attachable to the composite frame 120. The mechanical latching arrangement provides functionality for the composite roof panel 130 to be attached to and removed from the composite frame 120. The composite frame 120 may include a water seal that seals to the removable composite roof panel 130.

In the exemplary embodiment, the roof body 110 may include a front header 112, a rear header 114, a first side roof rail 116 and a second side roof rail 118. Additionally, a urethane adhesive may be used to bond the composite frame 120 to the roof body 110. Other types of adhesives may be suitable for bonding the composite frame 120 and the roof body 110. Also, the composite roof panel 130 may be manufactured of a plastic material.

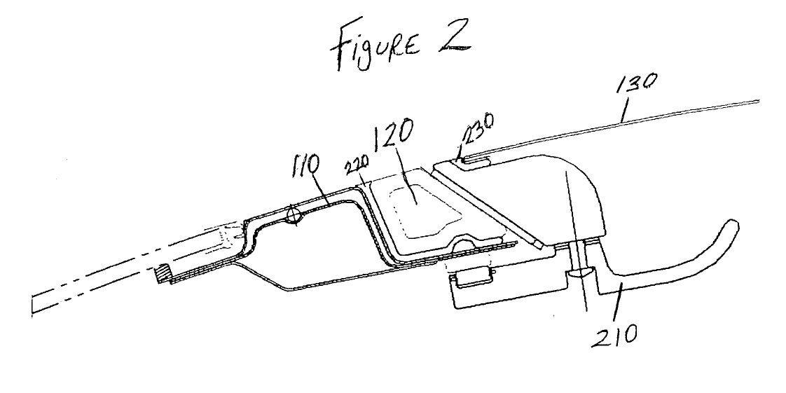

FIG. 2 shows a side of the exemplary embodiment of the roof system according to the present invention. The roof body 110 is bonded to the composite frame 120 with an adhesive 220. The latching arrangement 210 is used to attach the roof panel 130 to the composite frame 120. A water seal 230 is also used to bond the roof panel 130 and the composite frame 120.

Furthermore, the roof system according to the present invention allows vehicle owners to choose among various roof styles. Vehicle owners may choose among varying roof panels including, for example, a solid panel, a glass panel, a canvas retractable panel, an integral roof rack panel or another style of roof panel.

What is claimed is:

1. A roof system for a vehicle, comprising:
a roof body;
a composite frame that is bonded via an adhesive to the steel body-in-white roof body;
a removable composite roof panel that is attachable to the composite frame; and
a mechanical latching arrangement situated on the removable composite roof panel, the mechanical latching arrangement allows the removable composite frame to be attached to and removed from the composite frame.

2. The roof system of claim 1, wherein the roof body includes a front header, a rear header, a first side roof rail and a second side roof rail.

3. The roof system of claim 1, wherein a urethane adhesive bonds the composite frame to the roof body.

4. The roof system of claim 1, wherein the composite frame includes a water seal that seals to the removable composite roof panel.

5. The roof system of claim 1, wherein the composite frame is composed of a plastic material.

6. The roof system of claim 1, wherein the removable composite roof panel is one of a solid panel, a glass panel, a canvas retractable panel and an integral roof rack panel.

7. The roof system of claim 1, wherein the roof body is composed of a steel body-in-white material.

8. The roof system of claim 1, wherein the roof body is composed of a metal material.

9. The roof system of claim 1, wherein the roof body is composed of a fiberglass material.

10. The roof system of claim 1, wherein the roof body is composed of a plastic material.

11. The roof system of claim 1, wherein the roof body is composed of a composite material.
